(19) United States
(12) Patent Application Publication
(10) Pub. No.: US 2021/0238709 A1
(43) Pub. Date: Aug. 5, 2021

(54) Aluminium Purification

(71) Applicant: The University of Birmingham, Birmingham (GB)

(72) Inventor: Biao Cai, Birmingham (GB)

(73) Assignee: The University of Birmingham, Birmingham (GB)

(21) Appl. No.: 17/259,513

(22) PCT Filed: Jul. 12, 2019
(86) PCT No.: PCT/GB2019/051967

§ 371 Date: Jan. 11, 2021

(30) Foreign Application Priority Data
Jul. 12, 2018 (GB) 1811413.2

(51) Int. Cl. C22B 21/06; B03C 1/033; B03C 1/32

(52) U.S. Cl. CPC C22B 21/06; B03C 1/32; B03C 1/0332

(57) ABSTRACT

A method for separating iron from an aluminium alloy comprises providing a first zone of an aluminium alloy at a first temperature at which the aluminium alloy is partially melted and any iron-containing particles therein are fully molten, and providing a second zone of the alloy at a second temperature at which the aluminium alloy is fully molten, such that a temperature gradient is created between the first zone and the second zone. By applying a static homogeneous magnetic field to the alloy, and maintaining the temperature gradient and the magnetic field for a period of time, the iron content of the first and/or second zone can be reduced.

The present invention relates to a method of removing impurities from metals. In particular, the invention relates to a method of separating iron from aluminium alloys.

The energy requirement for producing aluminium from discarded aluminium (Al) products or scraps is 10-20 MJ/kg, whereas it is about 186 MJ/kg to produce primary aluminium from bauxite ore. This provides a significant attraction for promoting Al alloy recycling and the use of recycled Al alloys. Unfortunately, impurity elements, especially iron (Fe) and silicon (Si), accumulate in the alloys during the recycling processes, limiting the use of recycled Al products in premium applications such as aircraft. Iron is one of the most challenging impurity elements for Al alloy recycling. The Fe impurity stemming from the refining processes gradually accumulates over repeated recycling. Fe is usually considered to have the most detrimental effect, forming brittle intermetallics during solidification and degrading the mechanical properties of the alloy. Therefore, the level of Fe in Al alloys has to be stringently controlled. More importantly, Fe is extremely difficult to remove from Al alloys.

Methods to alleviate the adverse effect of Fe or to remove Fe from Al alloys have been limited. Indirect methods (e.g. dilution with primary Al, element neutralization and intensive shearing) have been reported before. One particular method—iron removal through sludge particle (α-Al₁₅(FeMn)₃Si₂) separation—has been well developed but it can only be used in Al—Si based casting alloys and additional manganese (Mn) is needed to form the Fe and Mn containing sludge particles in the fully liquid state. Those particles then can be removed through gravity separation and filtration, centrifugal separation or electromagnetic separation (Kim & Yoon, J. Mater. Sci. Lett. 19 (2000) 253-255). For the electromagnetic separation methods to work, the Fe-containing particles need to flow freely in the liquid, driven to move to predetermined locations by the electromagnetic force. This requires the formation of Fe-containing particles in the molten aluminium alloys. However, particles with such characteristics are difficult to identify and the process difficult to control, which limits the application of the electromagnetic separation technique to other Al alloys.

U.S. Pat. No. 8,673,048 B2 describes a method of removing iron impurities from aluminium alloys using a magnetic field gradient to confine distinct liquid or solid iron-containing phases to a predetermined region of the molten alloy, and then physically separating the iron-rich region from the melt. Since the iron-containing phases are only weakly magnetic, the magnetic field gradient is required in order for the particles to “flow”. However, this method relies on the presence of a separate iron-containing phase that exists while the aluminium alloy is molten.

The present invention has been devised with these issues in mind.

According to a first aspect of the present invention there is provided a method for separating iron from an aluminium alloy, the method comprising:
providing a first zone of an aluminium alloy at a first temperature at which the aluminium alloy is partially melted and any iron-containing particles therein are fully molten, and providing a second zone of the alloy at a second temperature at which the aluminium alloy is fully molten, such that a temperature gradient exists between the first zone and the second zone;
applying a static homogeneous magnetic field to the alloy in the presence of the temperature gradient; and
maintaining the temperature gradient and the magnetic field for a period of time sufficient to reduce the iron content of the first and/or second zone.

The method of the present invention therefore differs from the method of U.S. Pat. No. 8,673,048 B2 in that it uses a homogeneous magnetic field, rather than a magnetic field gradient. Additionally, the present invention involves heating the alloy to different temperatures in two different zones, thereby achieving a temperature gradient between the two zones, rather than heating the whole alloy to a single temperature as taught by U.S. Pat. No. 8,673,048 B2 The method of the present invention allows the formation of an iron enriched region that can be separated by physical methods. This avoids the need for Fe-containing phases in the liquid state.

Without being bound by theory, it is thought that the two zones of differing temperatures are necessary for the formation of an electric current circulating around the solid/liquid interface, due to the thermoelectric effect. With the imposing of the magnetic field, a Lorentz force is created, which drives the iron in both the liquid zone and the partially-melted zone to another region of the sample (for example, the interface between the two zones), thereby creating a distinct iron-enriched region.

One advantage of the method of the invention over prior art methods is that there is no requirement for a distinct iron-containing phase to be present in the alloy. This means that the method of the invention will be effective at separating iron from all types of aluminium alloys, rather than just those in which a distinct iron-containing phase already co-exists with molten aluminium. Instead, in the method of the invention the use of a temperature gradient and a homogeneous magnetic field causes an iron-enriched liquid layer to form.

The iron content in the first and/or second zone may be reduced to below a predetermined level. It will be understood that a “predetermined level” is the level of iron content which is desired or deemed acceptable by the operator of the method, and that certain applications of the recycled alloy will require a lower iron content than others. It is therefore envisaged that the skilled person will select the predetermined level according to the subsequent use of the alloy. In some embodiments, the predetermined level of the first and/or second zone may be less than 0.8%, less than 0.4%, less than 0.2%, less than 0.15% or less than 0.1% (by weight). The predetermined level for the first zone may be the same as that for the second zone, or the predetermined levels may be different for each zone.

In the first zone, the aluminium alloy is provided at a first temperature at which the aluminium alloy is partially melted. By “partially melted” it will be understood that the alloy is in a semi-solid state in which both solid grains and liquid alloy coexist. At the same time, the temperature within the first zone needs to be high enough to melt any iron-enriched particles into the liquid around the solid grains.

It will be appreciated that the first temperature will depend on the composition of the alloy and the iron-containing particles therein. A skilled person would be able to determine a temperature suitable for achieving the partially melted state. For example, a skilled person can determine the temperature using a published phase diagram of the alloy or experimentally using differential scanning calorimetry (DSC).

In some embodiments, the alloy in the first zone is provided at a first temperature of from 450° C. to 650° C., from 500° C. to 630° C., from 550° C. to 610° C., from 570° C. to 600° C. or from 580 to 590° C.

In the second zone, the aluminium alloy is provided at a second temperature at which the aluminium alloy is completely melted. It will be appreciated that the second temperature will depend on the composition of the alloy, and a skilled person would be able to determine a temperature suitable for achieving the fully molten state. The second temperature is higher than the first temperature.

In some embodiments, the second temperature is from 500° C. to 700° C., from 550° C. to 650° C., from 600° C. to 640° C., or from 610° C. to 630° C. (e.g. about 620° C.).

Any heating methods that enable the formation of a fully liquid zone and a partially-melted zone within the alloy are envisaged. In some embodiments, the temperature gradient is formed by at least one heater. In some embodiments, the temperature gradient is formed by at least two heaters, one which heats the first zone of the alloy to the first temperature, and another which heats the second zone of the alloy to the second temperature.

The magnetic field may be applied while the alloy is being brought to the first and second temperatures. Alternatively, the alloy may be provided at the first and second temperatures before being subjected to the magnetic field.

The magnetic field may be induced by one or more permanent magnets or one or more electromagnets or supermagnets.

It will be appreciated that the strength of the magnetic field may be selected according to a number of factors, including the type of magnet used and the time available for separating the iron from the alloy. In some embodiments the magnetic field has a strength of from 0.1 to 25 T, from 0.1 to 16 T, from 0.5 to 12 T, from 1 to 10 T or from 2 to 8 T. In some embodiments the magnetic field has a strength of at least 0.1, at least 0.5 or at least 1 T.

In some embodiments, the first and second zones are heated to the first and second temperatures, then the heating and the magnetic field are maintained together for a period of time sufficient to reduce the iron content of the first and/or second zone.

The period of time during which the alloy is heated and subjected to the magnetic field will depend on numerous factors including the type of alloy, the magnetic field strength, the temperatures of the first and second zones of the alloy, and the desired reduction in iron content of the alloy. A skilled person will be able to determine a suitable time period by sampling the alloy in the first and/or second zones and measuring its iron content. If the amount of iron is higher than desired, the exposure of the alloy to heating and the magnetic field can be continued until the iron content has been reduced to below the predetermined level.

In some embodiments the heating and the magnetic field are maintained for a period of time of from 10 minutes to 10 hours, from 15 minutes to 2 hours or from 30 minutes to 1 hour. In some embodiments the heating and the magnetic field are maintained for at least 10 hours (e.g. up to 24 hours).

In other embodiments, the first and second zones are heated to temperatures above the first and second temperatures respectively, so that the aluminium alloy is fully molten in both the first and second zones. The second zone is heated to a temperature greater than the temperature of the first zone, such that a temperature gradient exists across the aluminium alloy. The aluminium alloy is then cooled, while maintaining the temperature gradient, until the first zone reaches the first temperature and the second zone reaches the second temperature. The magnetic field is applied while the aluminium alloy is cooling.

By fully melting the aluminium alloy, and then cooling the aluminium alloy, while maintaining a temperature gradient in which the second zone is at a higher temperature than the first zone, the first zone begins to solidify before the second zone, thereby providing a first zone in which the aluminium alloy is partially melted and any iron-containing particles therein are fully molten and a second zone in which the aluminium alloy is fully melted.

Arriving at the first and second temperatures by cooling the alloy down from a higher temperature, rather than heating up to the first and second temperatures, provides an additional advantage in that there is no need to maintain heating to the two separate zones to keep one zone partially melted and the other zone fully molten, which can be more difficult to control. Furthermore, less energy for heating and less time for processing is required and the method is more flexible to set up.

In some embodiments, the aluminium alloy is cooled at a controlled rate, to optimize the period of time in which the first zone is partially melted and the second zone is fully molten. The alloy may be cooled by a cooling system, or by a controlled power down of the heater(s).

Applying a static homogenous magnetic field to the alloy for a period of time while the first zone is partially melted and the second zone is fully molten drives iron from the first zone and the second zone, resulting in the formation of an iron-enriched region. The level of iron in both zones will therefore be depleted.

Thus, the method of the invention results in the formation of an iron-enriched region. In some embodiments the method further comprises separating the iron-enriched region from the rest of the aluminium alloy.

In some embodiments, the iron-enriched layer is separated from the aluminium alloy while it is still in liquid form. For example, the iron-enriched region may be separated from the alloy by pouring, ladling, pumping, siphoning or any other convenient technique.

In other embodiments, the method further comprises completely solidifying the alloy. The alloy may be solidified by allowing it to cool, for example to room temperature. As a result, effectively two regions exist after cooling: an iron-enriched region and an iron-depleted region. The iron-depleted region may be substantially free from iron-containing particles. The two regions can then be separated by physical methods, for example by machining.

Thus, in some embodiments the method further comprises completely solidifying the alloy prior to separating the iron-enriched region from the alloy.

According to a second aspect of the present invention there is provided a method for separating iron from an aluminium alloy, the method comprising:
heating a first zone of an aluminium alloy to a first temperature at which the aluminium alloy is partially melted and any iron-containing particles therein are fully molten, and heating a second zone of the alloy to a second temperature at which the aluminium alloy is fully molten;
applying a static homogeneous magnetic field to the alloy; and
maintaining the heating and the magnetic field for a period of time sufficient to reduce the iron content of the first and/or second zone.

According to a third aspect of the invention, there is provided a method for separating iron from an aluminium alloy, the method comprising:
heating an aluminium alloy to a fully molten state, wherein a second zone of the alloy is heated to a higher temperature than a first zone of the alloy such that a temperature gradient exists across the alloy;
applying a static homogeneous magnetic field to the alloy; and
cooling the molten aluminium alloy while maintaining the temperature gradient and the magnetic field until the alloy is completely solidified.

The method of the first, second and third aspects of the invention may be carried out using the apparatus of the fourth aspect.

According to a fourth aspect of the invention, there is provided an apparatus for separating iron from an aluminium alloy, the apparatus comprising:
at least one heater arranged to heat an aluminium alloy in a first zone to a first temperature at which the alloy is partially melted, or to a temperature higher than the first temperature, and to heat the alloy in a second zone to a second temperature at which the aluminium alloy is fully molten, or to a temperature higher than the second temperature; and
a magnetic field generator for generating a homogenous magnetic field across the alloy.

In some embodiments, the apparatus comprises at least one heater arranged to heat the first and second zones under a temperature gradient. In other embodiments, the apparatus comprises two heaters, including a first heater and a second heater, with the first heater being arranged to heat the alloy in a first zone and the second heater being arranged to heat the alloy in a second zone. In other embodiments, multiple first heaters and/or multiple second heaters are provided. Preferably, the number of first heaters is equal to the number of second heaters. The apparatus may comprise two, three, four or more first heaters, and two, three, four or more second heaters. In some embodiments, two first heaters and two second heaters are provided.

The heater(s) are configured to provide a temperature gradient within the alloy. Any arrangement of the heaters is envisaged, provided that it is suitable for creating a temperature gradient within the alloy. For example, a first and a second heater may be positioned side by side, or one above the other.

In some embodiments, the apparatus may comprise a pair of opposing first heaters which are spaced apart. A pair of opposing second heaters may be provided, each one of the pair of second heaters being positioned adjacent to (e.g. above, below or next to) a respective first heater. The second heaters are thus spaced apart by the same distance as the pair of first heaters. In this arrangement, a vessel containing the alloy may be located between the pairs of first and second heaters.

In some embodiments, the at least one heater is in the form of a ring, tube or tunnel. In use, a vessel containing the alloy may be placed within the ring, tube or tunnel such that the heater(s) extends all the way around the vessel. This enables the alloy to be heated evenly.

In some embodiments, the apparatus further comprises a cooling system, for cooling the aluminium alloy at a controlled rate.

In some embodiments the apparatus further comprises a vessel (such as a crucible) for containing the molten alloy. The vessel may be formed from any material that is able to withstand the temperatures required to fully melt the alloy, for example refractory material.

The magnetic field generator may comprise a pair of permanent magnets. The magnets may be disposed within an iron yoke.

Alternatively, the magnetic field generator may comprise an electromagnet.

In some embodiments, the apparatus further comprises a thermal insulating layer disposed between the heaters and the magnetic field generator. This helps the magnetic field generator to operate effectively while the heaters are generating large amounts of heat sufficient to melt the alloy.

In some further embodiments, the apparatus comprises a water cooling plate. The water cooling plate may be inserted between the thermal insulating layer and the magnetic field generator. This further protects the magnetic field generator from the heat generated by the heaters.

The heaters and the magnetic field generator may be moveable relative to the vessel which (in use) contains the alloy. For example, the heaters and the magnetic field generator may be configured to move along an elongate vessel (which may remain stationary) containing an aluminium alloy. In such embodiments, the heaters and the magnetic field generator (either separately, or together as a unit) may be placed on rollers or wheels. In some embodiments, the apparatus may be configured to allow an elongate vessel containing an aluminium alloy to pass between the heaters and between a pair of magnets (which may remain stationary). These embodiments enable a large quantity of alloy to be treated in sections continuously.

The apparatus may be coupled into any casting technologies in line. The casting technologies may be squeeze casting, Bridgman casting, continuous casting, sand casting, or high pressure die casting.

It will be understood that any of the statements made above may apply equally to each of the first to fourth aspects of the invention, as appropriate.

Embodiments of the invention will now be described with reference to the accompanying figures in which:

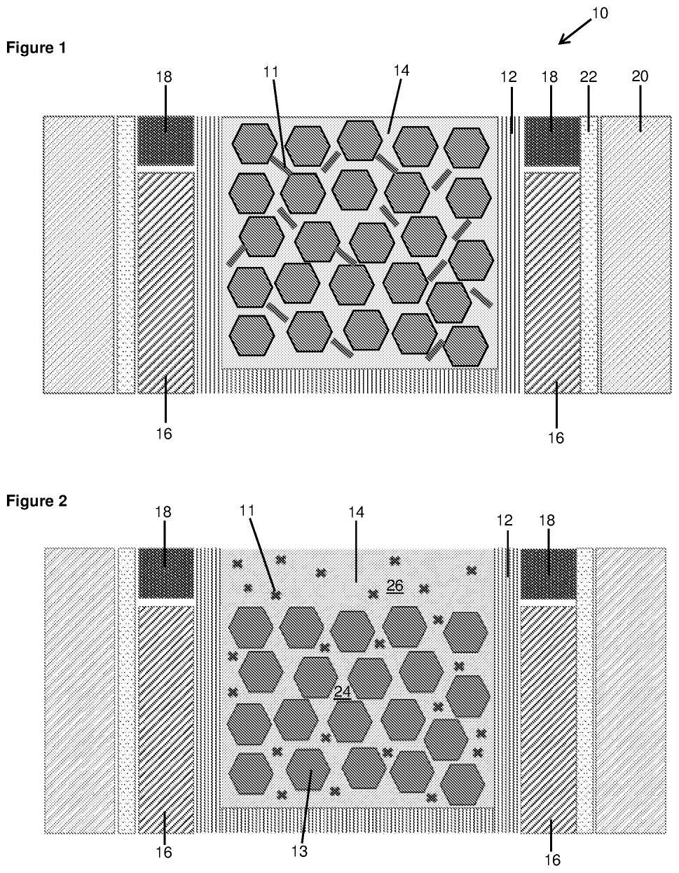

FIG. 1 is a schematic diagram of an apparatus in accordance with an embodiment of the invention, prior to heating the alloy;

FIG. 2 shows the apparatus of FIG. 1, after the alloy is heated;

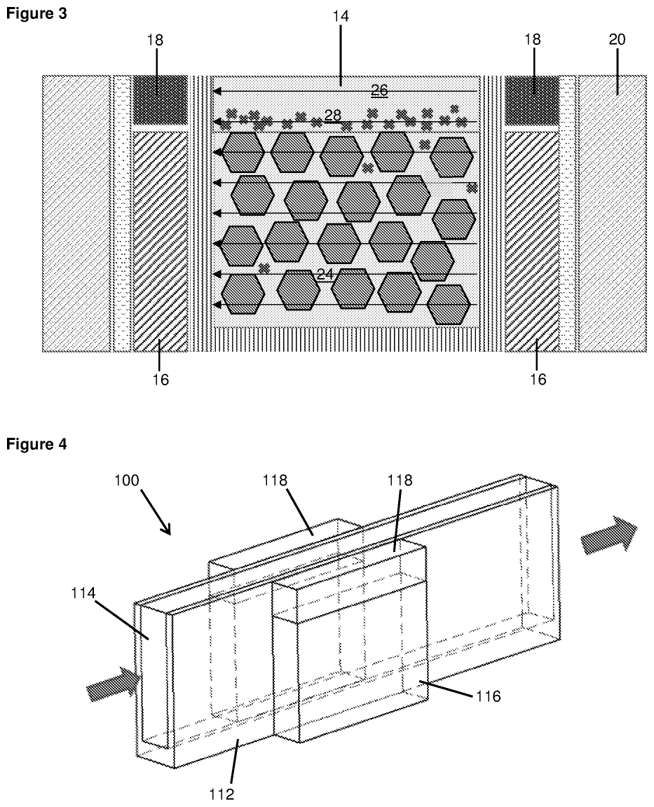

FIG. 3 shows the apparatus of FIGS. 1 and 2, after the alloy has been held under a temperature gradient and a magnetic field for a period of time;

FIG. 4 is a schematic diagram of an apparatus in which an elongate alloy is processed in accordance with embodiments of the invention;

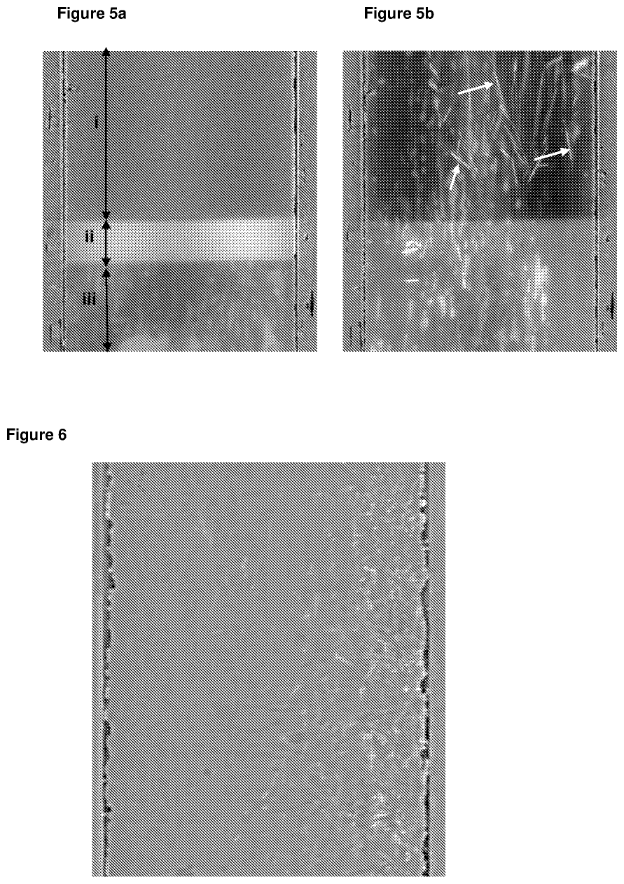

FIG. 5a is a vertical section of an X-ray tomographic image of an aluminium alloy after the alloy has been held under a temperature gradient and a magnetic field for a period of time, in accordance with an embodiment of the method of the present invention; and

FIG. 5b is a microscope image of the aluminium alloy of FIG. 5a, after cooling.

FIG. 6 is a microscope image of the Al-4Cu-1 Fe aluminium alloy after re-processing.

FIG. 1 shows an apparatus 10 for separating iron (Fe) from an aluminium alloy. The apparatus 10 comprises a crucible 12 which contains the aluminium alloy 14. The aluminium alloy 14 contains Fe contaminants in the form of Fe-enriched particles or intermetallics 11 around the grain boundaries of the alloy.

On either side of the crucible 12 there is a lower heating element 16 and an upper heating element 18. The apparatus 10 further comprises a magnetic field generator 20 comprising an opposing pair of permanent magnets that will generate a transversal magnetic field across the sample. The magnetic field generator 20 is placed outside of the heating elements 16, 18 in the embodiment shown. To keep the magnetic field generator 20 below its working temperature, it is separated from the heating elements 16, 18 by a high performance thermal insulating layer 22. A water cooling plate can also be inserted between the insulating layer 22 and the magnetic field generator 20 if needed (not shown).

The apparatus will now be described in use with reference to FIG. 2. The heating elements 16, 18 are turned on in order to heat the aluminium alloy 14 within the crucible 12. The lower heating elements 16 heat the alloy in a first zone 24 to a first temperature which is sufficient to keep the aluminium alloy 14 in a semi-solid condition in which the solid grains and liquid coexist. The upper heating elements 18 heat the alloy 14 in a second zone 26 to a second temperature which fully melts the alloy 14. The temperature in the first zone 24 is also high enough to melt the Fe-enriched particles 11 into the liquid which surrounds the solid grains 13 within the alloy 14. Thus, a temperature gradient is established across the alloy forming a liquid zone 26 and a semi-solid zone 24 in which Fe-particles 11 are fully re-melted into the liquid.

With reference to FIG. 3, a static homogenous magnetic field is provided by the magnetic field generator 20, as indicated by the arrows. The alloy 14 is held under the temperature gradient and the magnetic field for a period of time, causing Fe to move from the molten and semi-molten zones 24, 26 to the interface of the zones 24, 26. This results in the formation of an Fe-enriched layer 28 between the two zones 24, 26 and a consequent reduction in the amount of Fe present in these zones. The Fe-enriched layer 28 can then be removed directly from the liquid alloy, for example by pouring, ladling or pumping. Alternatively, the heating elements 16, 18 can be switched off or powered down in a controlled manner, allowing the alloy to cool to room temperature and solidify. The resulting Fe-enriched layer can then be separated from the rest of the alloy, e.g. by machining.

FIG. 4 shows an apparatus 100 in which an elongate sample of alloy 114 is processed in stages. The apparatus comprises a crucible 112 in which the elongate alloy sample 114 is received. On each side of the crucible 112 there is a lower heating element 116 and an upper heating element 118. A pair of opposing permanent magnets (not shown) is disposed outside of the heating elements 116, 118. The crucible 112 with the sample 114 within is moveable relative to the apparatus 100, as indicated by the arrow. It will be appreciated that the crucible 112 containing the sample 114 may move while the heating elements 116, 118 and magnets are stationary, or that the heating elements 116, 118 and magnets may move along the length of the crucible 112.

In use, the heating elements 116, 118 heat a portion of the sample 114 that is disposed between them, thereby creating first and second zones in the alloy as previously described. A static homogenous magnetic field is applied, causing the formation of a Fe-enriched layer between these zones. The crucible 112 is then moved relative to the heaters 116, 118 and magnets so that the treated portion of the sample 114 is no longer subject to heating or the magnetic field and is allowed to cool, while the next portion of the sample 114 is received between the heating elements 116, 118 and magnets and treated in the same way. The process is repeated until the whole length of the sample is treated. This results in a Fe-enriched band across the full length of the sample, which may then be separated from the rest of the solidified sample as previously described.

### EXAMPLE 1

The method of the invention was tested using the alloy Al-7Si-3.5Cu-0.8Fe (weight percent). The alloys formed plate-shape β (Al₅SiFe) intermetallics around grain boundaries. The sample (1.8 mm diameter) was partially melted under two heaters. The temperature in the upper region of the sample (fully molten zone) was around 620° C. while the temperature in the lower region of the sample (partially molten zone) was around 580 to 590° C. While the temperatures of the zones were maintained, the sample was held in a steady and homogeneous transverse magnetic field of 0.5 T for 25 min.

As shown in FIG. 5a, three distinctive layers were observed: (i) the top layer—fully molten alloy; (ii) the middle layer—enriched with iron; and (iii) the bottom layer—semi-solid alloy (a zone where liquid and solid co-exist).

After the holding period, the sample was cooled down to room temperature under the same magnetic field. As shown in FIG. 5b, after solidification the bottom part of the sample (corresponding to the partially molten zone (iii) of FIG. 5a) was almost free of plate-shape β (Al5SiFe) intermetallics (volume fraction 0.002). There were significantly more β intermetallics formed within the top region of the sample (corresponding to the top liquid zone (i) and the iron-rich layer (ii) of FIG. 5a), as indicated by the arrows (volume fraction 0.024). This demonstrates the successful separation of the iron-containing β phase in Al—Cu—Si based alloys.

### EXAMPLE 2

The method of the invention was tested using the alloy Al-4Cu-1Fe (weight percent). The sample (1.8 mm diameter) was fully melted at a temperature gradient of 20° C./mm and held for 5 min for temperature homogenization. Afterwards, a 1 T transversal magnetic field was applied, and the sample was cooled down within the 1 T magnetic field at 6° C./min. The results show that Fe-containing intermetallics (Al₃Fe and Al₇Cu₂Fe) were aggregated on one side of the sample (FIG. 6). This demonstrates that Fe can be successfully separated from Al—Cu based alloys.

1. A method for separating iron from an aluminium alloy, the method comprising:
providing a first zone of an aluminium alloy at a first temperature at which the aluminium alloy is partially melted and any iron-containing particles therein are fully molten, and providing a second zone of the alloy at a second temperature at which the aluminium alloy is fully molten, such that a temperature gradient is created between the first zone and the second zone,
applying a static homogeneous magnetic field to the alloy; and
maintaining the temperature gradient and the magnetic field for a period of time sufficient to reduce the iron content of the first and/or second zone to below a predetermined level.

2. The method of claim 1, wherein the first temperature is from 450° C. to 650° C.

3. The method of claim 1, wherein the second temperature is from 500° C. to 700° C.

4. The method of claim 1, wherein the magnetic field strength is from 0.1 to 16 T.

5. The method of claim 1, wherein the alloy is heated up to the first and second temperatures, then the heating and the magnetic field are maintained together for a period of time sufficient to reduce the iron content of the first and/or second zone.

6. The method of claim 5, wherein the heating and magnetic field are maintained for a period of time of from 10 minutes to 10 hours.

7. The method of claim 1, wherein the alloy is fully melted, then cooled until the first zone reaches the first temperature and the second zone reaches the second temperature, and wherein the magnetic field is applied while the alloy is cooling.

8. The method of claim 7, wherein the alloy is cooled at a controlled rate.

9. The method of claim 1, wherein the application of the magnetic field results in the formation of an iron-enriched layer, the method further comprising separating the iron-enriched layer from the alloy.

10. The method of claim 9, wherein the iron-enriched layer is separated from the alloy while it is in liquid form.

11. The method of claim 9, wherein the method further comprises solidifying the alloy prior to separating the iron-enriched layer from the alloy.

12. The method of claim 11, wherein the iron-enriched layer is separated from the alloy by machining.

13. The method of claim 1, wherein the temperature gradient is formed by at least two heaters, one which heats the first zone of the alloy to the first temperature, and another which heats the second zone of the alloy to the second temperature.

14. An apparatus for separating iron from an aluminium alloy, the apparatus comprising:
at least one heater arranged to heat an aluminium alloy in a first zone to a first temperature at which the alloy is partially melted, and to heat the alloy in a second zone to a second temperature at which the aluminium alloy is fully molten; and
a magnetic field generator for generating a homogenous magnetic field across the alloy.

15. The apparatus of claim 14, wherein the magnetic field generator comprises a pair of permanent magnets.

16. The apparatus of claim 14, wherein the apparatus comprises a first heater arranged to heat the alloy in the first zone and a second heater arranged to heat the alloy in the second zone.

17. The apparatus of claim 14, further comprising a vessel for containing the molten alloy.

18. The apparatus of claim 14, further comprising a thermal insulating layer disposed between the heaters and the magnetic field generator.

19. The apparatus of claim 18, further comprising a water cooling plate disposed between the thermal insulating layer and the magnetic field generator.

20. The method of claim 10, wherein the iron-enriched layer is separated from the alloy by pouring, ladling or pumping.
